(19) United States
(12) Patent Application Publication
(10) Pub. No.: US 2010/0052195 A1
(43) Pub. Date: Mar. 4, 2010

(54) Optical film structure and a manufacturing method thereof

(76) Inventors: Yu Wei Chang, Taipei City (TW); Kai-Hsin Li, Sinjhuang City (TW); Chen-Yu Hsieh, Bade City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/230,268

(22) Filed: Aug. 27, 2008

(51) Int. Cl. B29D 11/00; G02B 5/02; B32B 5/02; B32B 27/00

(52) U.S. Cl. 264/1.7; 428/325; 428/327; 428/411.1; 428/412; 428/480; 428/522; 428/500; 428/215

(57) ABSTRACT

An optical film structure and a manufacturing method thereof are disclosed. By using the co-extrusion manufacturing process, the substrate, the first light-transparent material, and the second light-transparent material are combined into one piece to change the light path. By using the rolling way, the surface of the first light-transparent material directly forms a light-guiding micro-structure. Furthermore, at least one layer out of the substrate, the first light-transparent material, and the second light-transparent material are added with the diffusion particles to form the optical film structure that has an anti-scratch effect and high yield rate. Therefore, the present invention provides a uniform optical film structure that is formed into one piece by using the co-extrusion manufacturing process to prevent the structure from being warped due to environmental variations. By adding the diffusion particles on the optical film structure, the improved optical film having anti-scratch effect and high yield rate is formed.

### BACKGROUND OF THE INVENTION

1. Field of the Invention

The present invention relates to an optical film structure and a manufacturing method thereof; more particularly, the present invention relates to an optical film structure and a manufacturing method thereof that use different cubic structures and diffusion particles to form the optical film structure with different structure and shape.

2. Description of the Related Art

As digital TV develops, liquid crystal display (LCD) becomes popular in the display field. The sales volume is kept at a high growth rate due to high demand. The image-forming method of the LCD is to utilize the switch of the electrical field to drive and display high quality image. The LCD does not emit light, and needs a backlight module to provide light for the display.

Generally, the backlight for the large-scaled LCD is a bottom backlight. By increasing the quantity of the lamps of the bottom backlight and the diffusion element, high brightness and uniform light is achieved. In order to meet the requirement of high brightness, the prism film is a key component to focus the light beam for the bottom backlight module. The function of the prism films is to change the light path of the light beam. The triangle structure of the surface of the prism film makes the light beam focus towards the normal direction so as to enhance the brightness.

Although the light-focusing effect of the prism films meets the requirement, it still needs an. UV hardening manufacturing process. It uses optical adhesive to transfer the shape of the mold onto the substrate, wherein the substrate is poly-ethylene terephthalate (PET). The angle of cubic structure is between 70 and 130 degrees. In order to prevent the cubic structure from directly contacting the high hardness surface (such as LCD panel) and scratch the surface, a diffusion film is placed above the prism film. Furthermore, the manufacturing method for the prism film is to use optical adhesive to transfer the shape of the mold onto the substrate. The processes include gluing, pressing, hardening, and releasing, etc. It is easy to damage the prism film due to complicated operation in the releasing process. Therefore, the manufacturing process is complex, and the yield rate is low.

Moreover, because the contraction ratios of the substrate and the forming glue are different, the prism film will be warped in the reliability test. In the structure of the prism film of the prior art, the UV hardening coating is formed on the substrate. Therefore, the prism film easily acquires defects, such as scratches. Its manufacturing process is complex and the yield rate is low.

### SUMMARY OF THE INVENTION

One particular aspect of the present invention is to provide an optical film structure and a manufacturing method thereof. By designing different structures, a variety of optical film structures are formed so that the light path is changed due to the refraction or reflection of the film structures to re-allocate the light beam. Furthermore, by disposing the diffusion particles, the light beam emitted into the film structure is uniform so as to reduce or prevent the optical film structure defect and improve the yield rate. Thereby, the optical film structure can provide uniform light beam and the warped problem is avoided.

The optical film structure is formed by the co-extrusion manufacturing process. The optical film structure includes a substrate layer, a first light-transparent layer, and a second light-transparent layer. The substrate layer has a light-emitting surface and a light-entering surface. The first light-transparent layer is located on the light-emitting surface of the substrate layer, and the surface of the first light-transparent layer forms a light-guiding micro-structure. The second light-transparent layer is located on the light-entering surface of the substrate layer. At least one layer out of the substrate layer, the first light-transparent layer, and the second light-transparent layer is added with a plurality of diffusion particles.

The present invention also provides a manufacturing method for the optical film structure. The manufacturing method for the optical film structure includes the following steps. First, a substrate, a first light-transparent material, and a second light-transparent material are provided. At least one of the substrate, the first light-transparent material, and the second light-transparent material are selectively added with a plurality of diffusion particles by using a single-axial or a dual-axial extrusion machine, wherein the plurality of diffusion particles are added while under a melted status. Finally, by using the co-extrusion manufacturing process, the first light-transparent material and the second light-transparent material are respectively pressed onto the front surface and the rear surface of the substrate, and a light-guiding micro-structure is formed on the surface of the first light-transparent material by a press forming roller.

When the LCD panel is shined by the cold cathode fluorescent lamp (CCFL) for a long period of time, the LCD panel becomes yellow in color and generates problems of color-temperature and the color-difference. Therefore, an UV absorbing additive are added in the substrate layer, the first light-transparent layer, and the second light-transparent layer to prevent the optical film from becoming yellow in color. The absorbing wave length of the UV absorbing additive is between 280 nm and 380 nm.

For further understanding of the present invention, reference is made to the following detailed description illustrating the embodiments and examples of the present invention. The description is for illustrative purpose only and is not intended to limit the scope of the claim.

### BRIEF DESCRIPTION OF THE DRAWINGS

The drawings included herein provide a further understanding of the present invention. A brief introduction of the drawings is as follows:

FIG. 1 is a schematic diagram of the optical film structure of the first embodiment of the present invention;

FIG. 2 is a schematic diagram of the optical film structure of the second embodiment of the present invention;

FIG. 3 is a schematic diagram of the optical film structure of the third embodiment of the present invention;

FIG. 4 is a schematic diagram of the optical film structure of the fourth embodiment of the present invention;

FIG. 5 is a flow chart of the manufacturing method for the optical film structure of the present invention;

FIG. 6 is a schematic diagram of the press forming operation of the optical film structure of the present invention; and

FIG. 7 is a schematic diagram of the roller rolling operation of the optical film structure of the present invention.

### DETAILED DESCRIPTION OF THE PREFERRED EMBODIMENTS

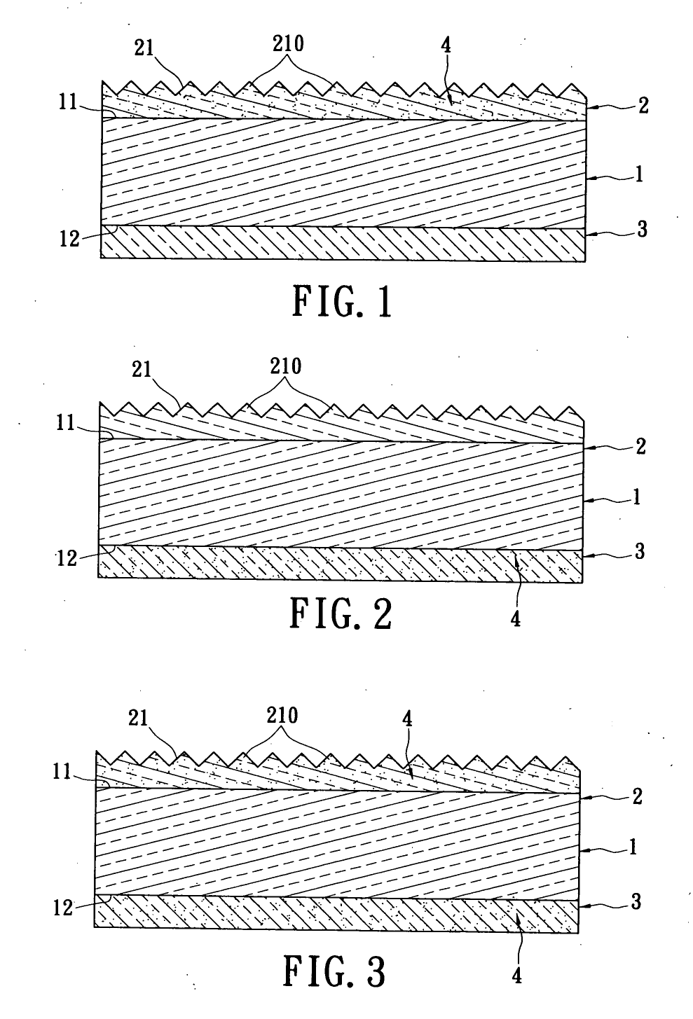

Reference is made to FIG. 1, which shows a schematic diagram of the optical film structure of the first embodiment of the present invention. The optical film structure includes a substrate layer 1, a first light-transparent layer 2, and a second light-transparent layer 3. By using the co-extrusion manufacturing process, the substrate layer 1, the first light-transparent layer 2, and the second light-transparent layer 3 are combined. The substrate layer 1, the first light-transparent layer 2, and the second light-transparent layer 3 are made of plastic material. The plastic material can be poly-styrene (PS), methly-methacrylate-styrene (MS), poly-carbonate (PC), poly-ethylene terephthalate (PET), copolyester (COP), poly-propylen (PP), poly-methyl meth-acrylate (PMMA, also known as acrylic glass), or other plastic materials with the same characteristic.

The substrate layer 1 is the key structure of the optical film structure, and has a light-emitting surface 11 and a light-entering surface 12 that is opposite to the light-emitting surface 11, wherein the two surfaces are respectively used as the combination surfaces for the first light-transparent layer 2 and the second light-transparent layer 3. Furthermore, the thickness of the optical film structure is between 50 μm and 1000 μm, and the ratio of the thickness between the substrate layer, the first light-transparent layer, and the second light-transparent layer is between 1:1.98:1 and 1:2.2:1. However, this ratio range is not meant to be limiting.

The first light-transparent layer 2 is located on the light-emitting surface 11, and is used as a light-emitting structure of the optical film structure for splitting the light beam to enhance the uniform of the light beam. The surface of the first light-transparent layer 2 forms a light-guiding micro-structure 21 for guiding the light beam. The angle of the light beam can be adjusted to re-allocate the light beam to enhance the lighting efficiency. The light-guiding micro-structure 21 can be a plurality of cone-shaped structures 210. The shape of the cone-shaped structures 210 can be triangle-cone, ladder-shaped, or non-spherical shape. The tiny end (i.e. the top of the triangle) of the triangle-cone is a smooth arc.

In the first embodiment, the first light-transparent layer 2 is added with a plurality of diffusion particles 4 for splitting and uniforming the light beam so as to enhance the light diffusion effect of the first light-transparent layer 2, and to prevent the first light-transparent layer 2 from being scratched or worn. The diffusion particles 4 are used for replacing the conventional diffusion film. The volume ratio between the diffusion particles 4 and the first light-transparent layer 2 is between 0.1% and 20%. The diameter of the diffusion particle 4 is between 0.1 μm and 50 μm for increasing the light diffusion efficiency. The diffusion particle 4 is made of poly-styrene (PS), poly-methyl meth-acrylate (PMMA, also known as acrylic glass), silicon dioxide (SiO₂), silicone, or other materials with the characteristic that is the same as PS, PMMA, SiO₂ or silicone.

Alternatively, an ultra-violet (UV) absorbing additive are selectively added to one, two, or all three layers; wherein the three layers are the substrate layer 1, the first light-transparent layer 2, and the second light-transparent layer 3. And this addition of the UV absorbing additives to at least one layer out of the substrate layer 1, the first light-transparent layer 2, and the second light-transparent layer 3 is to prevent the optical film from becoming yellow. In this embodiment, the second light-transparent layer 3 is located on the light-entering surface 12 of the substrate layer 1 and added with the UV absorbing additive. The second light-transparent layer 3 is used as a light-entering structure of the optical film structure for the light beam to enter and for splitting the light beam.

By utilizing the structure design of the substrate layer 1, the first light-transparent layer 2, the second light-transparent layer 3, and the diffusion particles 4, the optical film structure can change the light path, has an anti-scratch effect and make the light beam more uniform.

Reference is made to FIG. 2, which shows a schematic diagram of the optical film structure of the second embodiment of the present invention. The difference between the second embodiment and the first embodiment is:

The diffusion particles 4 are added to the second light-transparent layer 3 for splitting and uniforming the light beam so as to enhance the light diffusion effect of the second light-transparent layer 3, and to prevent the second light-transparent layer 3 from being scratched or worn. The volume ratio between the diffusion particles 4 and the second light-transparent layer 3 is between 0.1% and 20%.

Reference is made to FIG. 3, which shows a schematic diagram of the optical film structure of the third embodiment of the present invention. The difference between the third embodiment and the first embodiment is:

The diffusion particles 4 are added to the first light-transparent layer 2 and the second light-transparent layer 3 so as to enhance the light diffusion effect of the first light-transparent layer 2 and the second light-transparent layer 3, and to prevent the first light-transparent layer 2 and the second light-transparent layer 3 from being scratched or worn. The volume ratio between the diffusion particles 4 and the substrate layer 1, the first light-transparent layer 2, or the second light-transparent layer 3 is between 0.1% and 20%.

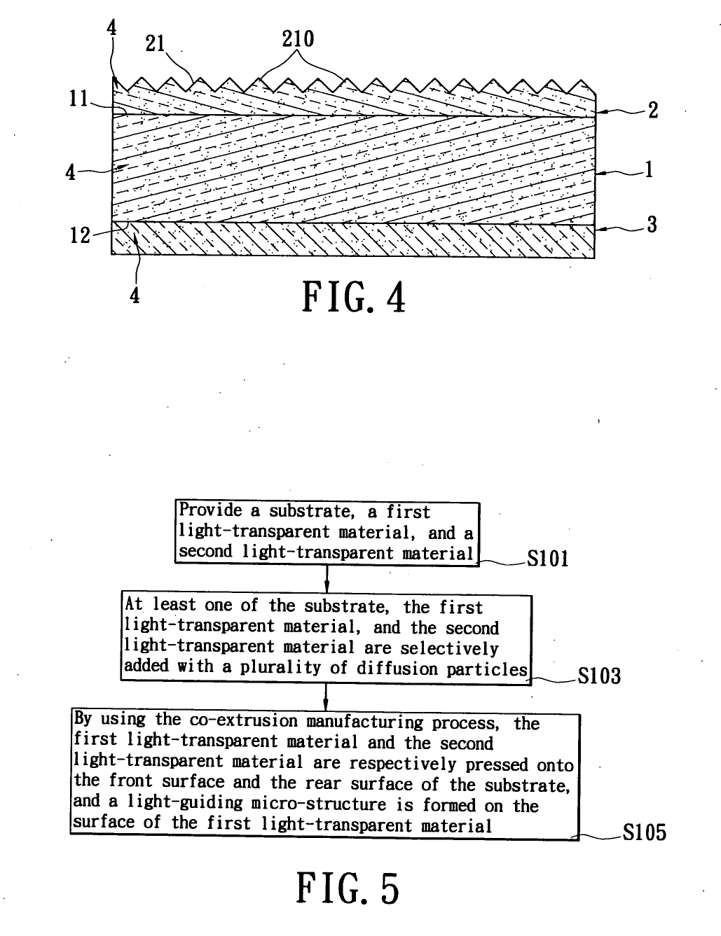

Reference is made to FIG. 4, which shows a schematic diagram of the optical film structure of the fourth embodiment of the present invention. The difference between the fourth embodiment and the first embodiment is:

The diffusion particles 4 are added to the substrate layer 1, the first light-transparent layer 2 and the second light-transparent layer 3 so as to enhance the light diffusion effect of the substrate layer 1, the first light-transparent layer 2, and the second light-transparent layer 3.

Reference is made to FIGS. 5˜7, which show the flow chart of the manufacturing method for the optical film structure of the present invention and the schematic diagrams of the operation processes. The manufacturing method for the optical film structure includes the following steps.

The first step, a substrate 5, a first light-transparent material 6, and a second light-transparent material 7 are provided (S101). The substrate 5 is a primary extrusion structure, and is located between the first light-transparent material 6 and the second light-transparent material 7. The first light-transparent material 6 and the second light-transparent material 7 is a secondary extrusion structure for matching the primary extrusion structure. The substrate 5, the first light-transparent material 6, and the second light-transparent material 7 are made of plastic material. The plastic material is poly-styrene (PS), methly-methacrylate-styrene (MS), poly-carbonate (PC), poly-ethylene terephthalate (PET), copolyester (COP), poly-propylen (PP), or poly-methyl meth-acrylate (PMMA).

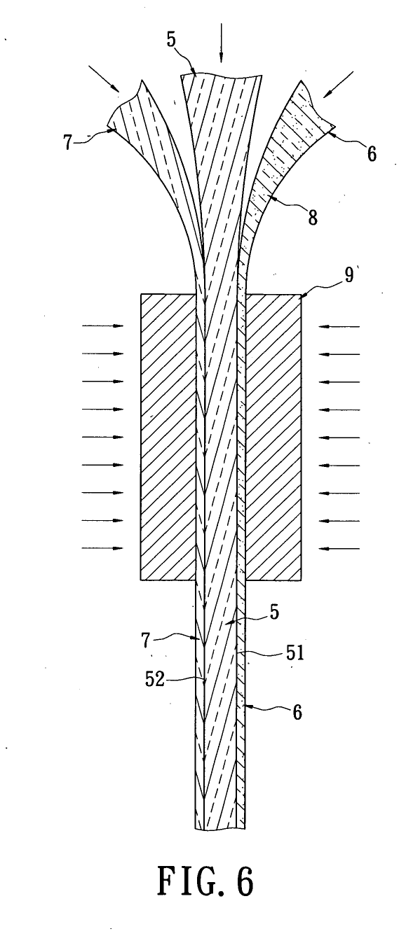

The second step, at least one layer out of the substrate 5, the first light-transparent material 6, and the second light-transparent material 7 are selectively added with diffusion particles 8 (S103). The diffusion particles 8 can be added to the first light-transparent material 6; or the diffusion particles 8 can be added to the second light-transparent material 7; or the diffusion particles 8 can be added to all three layers, wherein the three layers are the substrate 5, the first light-transparent material 6, and the second light-transparent material 7. By utilizing the diffusion particles 8, the light diffusion effect of the substrate 5, the first light-transparent material 6, and the second light-transparent material 7 are enhanced, and the structure of the first light-transparent material 6 and the second light-transparent material 7 is protected from scratch and worn. As shown in FIG. 6, the substrate 5, the first light-transparent material 6, and the second light-transparent material 7 is added with the diffusion particles 8.

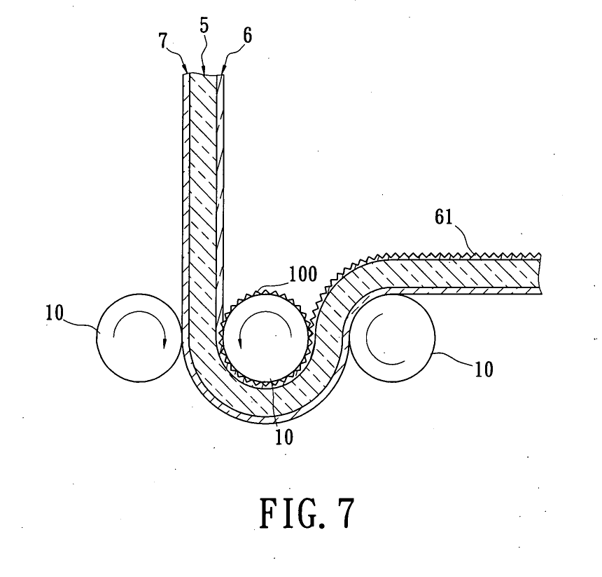

The third step, by using the co-extrusion manufacturing process, the first light-transparent material 6 and the second light-transparent material 7 are respectively pressed onto the front surface 51 and the rear surface 52 of the substrate 5, and a light-guiding micro-structure 61 is formed on the surface of the first light-transparent material 6 (S105). As shown in FIGS. 6 and 7, the co-extrusion manufacturing process includes heating and melting, pressing and forming, and rolling operations. The substrate 5, the first light-transparent material 6, and the second light-transparent material 7 are heated and melted in advance, and an extrusion forming operation is performed to combine the substrate 5, the first light-transparent material 6, and the second light-transparent material 7 into an optical film structure by using a co-extrusion die 9. Next, by performing a roller rolling operation that is composed of a plurality of rollers 10, the optical film structure is rolled and pressed to form a pre-determined shape. In the rolling operation, the roller 10 that first contacts the first light-transparent material 6 has a plurality of cone-shaped structures 100. The shape of the cone-shaped structures 100 can be triangle-cone, ladder-shaped, or non-spherical shape. The tiny end (i.e. the top of the triangle) of the triangle-cone is a smooth arc. By utilizing the roller rolling operation, the surface of the first light-transparent material 6 is rolled to form a light-guiding micro-structure 61, and the light-guiding micro-structure 61 has a plurality of cone-shaped structures. The shape of the cone-shaped structures can be triangle-cone, ladder-shaped, or non-spherical shape. The tiny end (i.e. the top of the triangle) of the triangle-cone is a smooth arc.

The present invention has the following characteristics:

1. By utilizing the co-extrusion manufacturing process and adding the diffusion particles, it can prevent the optical film structure from being scratched and worn. By utilizing the light diffusion effect, the tiny defect of the optical film structure can be compensated.

2. By utilizing the co-extrusion manufacturing process, all structures can be directly formed into one piece, and are not affected by environmental variation, such as the problem of the structure warp due to the contraction ratios of the substrate and the adhesives being different.

3. By using the diffusion particles to replace the diffusion film, the diffusion effect still can be achieved.

The description above only illustrates specific embodiments and examples of the present invention. The present invention should therefore cover various modifications and variations made to the herein-described structure and operations of the present invention, provided they fall within the scope of the present invention as defined in the following appended claims.

What is claimed is:

1. An optical film structure, formed by a co-extrusion manufacturing process, comprising:
a substrate layer having a light-emitting surface and a light-entering surface;
a first light-transparent layer located on the light-emitting surface of the substrate layer, wherein the surface of the first light-transparent layer forms a light-guiding micro-structure; and
a second light-transparent layer located on the light-entering surface of the substrate layer;
wherein at least one layer out of the substrate layer, the first light-transparent layer, and the second light-transparent layer is added with a plurality of diffusion particles and an UV absorbing additive.

2. The optical film structure as claimed in claim 1, wherein the diffusion particles are made of poly-styrene (PS), poly-methyl meth-acrylate (PMMA), silicon dioxide (SiO2), or silicone, and the diameters of the diffusion particles are between 0.1 μm and 50 μm.

3. The optical film structure as claimed in claim 1, wherein the volume ratio of the diffusion particles to the substrate layer, the first light-transparent layer, or the second light-transparent layer is between 0.1% and 20%.

4. The optical film structure as claimed in claim 1, wherein the substrate layer, the first light-transparent layer and the second light-transparent layer are made of plastic material, and the plastic material is poly-styrene (PS), methly-methacrylate-styrene (MS), poly-carbonate (PC), poly-ethylene terephthalate (PET), copolyester (COP), poly-propylen (PP), or poly-methyl meth-acrylate (PMMA).

5. The optical film structure as claimed in claim 1, wherein the thickness of the optical film structure is between 50 μm and 1000 μm, and the ratio of the thickness between the substrate layer, the first light-transparent layer, and the second light-transparent layer is between 1:1.98:1 and 1:2.2:1.

6. The optical film structure as claimed in claim 1, wherein the light-guiding micro-structure includes a plurality of cone-shaped structures, the shape of the cone-shaped structures is triangle-cone, ladder-shaped, or non-spherical shape, and the tiny end of the triangle-cone is a smooth arc.

7. A manufacturing method for the optical film structure, comprising:
(a) providing a substrate, a first light-transparent material, and a second light-transparent material;
(b) at least one of the substrate, the first light-transparent material, and the second light-transparent material are selectively added with a plurality of diffusion particles and an UV absorbing additive;
(c) by using the co-extrusion manufacturing process, the first light-transparent material and the second light-transparent material are respectively pressed onto the front surface and the rear surface of the substrate, and a light-guiding micro-structure is formed on the surface of the first light-transparent material.

8. The manufacturing method for the optical film structure as claimed in claim 7, wherein the step (c) is implemented by a roller rolling operation to combine the substrate, the first light-transparent material, and the second light-transparent material into one piece, and the light-guiding micro-structure is formed on the surface of the first light-transparent material.

9. The-manufacturing method for the optical film structure as claimed in claim 7, wherein the light-guiding micro-structure includes a plurality of cone-shaped structures, the shape of the cone-shaped structures is triangle-cone, ladder-shaped, or non-spherical shape, the tiny end of the triangle-cone is a smooth arc; and
the substrate, the first light-transparent material, and the second light-transparent 1 material are made of plastic material, and the plastic material is poly-styrene (PS), methly-methacrylate-styrene (MS), poly-carbonate (PC), poly-ethylene terephthalate (PET), copolyester (COP), poly-propylen (PP), or poly-methyl meth-acrylate (PMMA).

10. The manufacturing method for the optical film structure as claimed in claim 7, wherein the diffusion particles are made of poly-styrene (PS), poly-methyl meth-acrylate (PMMA), silicon dioxide (SiO2), or silicone, the diameters of the diffusion particles are between 0.1 μm and 50 μm, and the volume ratio of the diffusion particles to the substrate, the first light-transparent material, or the second light-transparent material is between 0.1% and 20%.
